(19) United States
(12) Patent Application Publication
(10) Pub. No.: US 2017/0078694 A1
(43) Pub. Date: Mar. 16, 2017

(54) IMAGE ENCODING APPARATUS, IMAGE DECODING APPARATUS, IMAGE ENCODING METHOD, IMAGE DECODING METHOD, AND COMPUTER READABLE MEDIUM

(71) Applicant: MITSUBISHI ELECTRIC CORPORATION, Tokyo (JP)

(72) Inventor: Katsuhiro KUSANO, Tokyo (JP)

(73) Assignee: MITSUBISHI ELECTRIC CORPORATION, Tokyo (JP)

(21) Appl. No.: 15/120,183

(22) PCT Filed: Mar. 4, 2014
(86) PCT No.: PCT/JP2014/055467

§ 371 Date: Aug. 19, 2016

(51) Int. Cl. H04N 19/59; H04N 19/33; H04N 19/167

(52) U.S. Cl. CPC H04N 19/59; H04N 19/167; H04N 19/33

(57) ABSTRACT

An image encoding apparatus includes an image transformation unit which transforms an input image signal with a first resolution to a second image signal with a second resolution lower than the first resolution, a region acquisition unit which acquires an attention region of an image indicated by the input image signal, a region information output unit which outputs first region information indicating the attention region, a first encoding unit which acquires a partial region signal corresponding to the attention region from the input image signal and encodes the partial region signal to a first encoded signal, a second encoding unit which encodes the second image signal to a second encoded signal, and an output unit which outputs the second encoded signal and the first encoded signal.

### TECHNICAL FIELD

The present invention relates to an image encoding apparatus, an image decoding apparatus, an image encoding method, an image decoding method, and a program. Specifically, the present invention relates to an image encoding apparatus which encodes an image, and an image decoding apparatus which decodes encoded data.

### BACKGROUND ART

Recently, a technique for compressing and encoding a moving image has been widely used. As an encoding system for a moving image, there are, for example, Moving Picture Expert Group (MPEG-2) system and MPEG-4 Advanced Video Coding (AVC)/ITU-T H.264 system (see, for example, Non Patent Literature 1).

MPEG-2 system is adopted by Digital Versatile Disk (DVD)-VIDEO.

MPEG-4 AVC/ITU-T H.264 system is adopted by terrestrial digital broadcasting (one-segment broadcasting) for mobile terminals, Blu-ray (registered trademark) Disk, and the like.

Furthermore, MPEG-4 AVC/H.264 can perform hierarchal encoding (see Non Patent Literature 1, Annex G Scalable Video Coding).

In the hierarchal encoding, when an enhancement layer prediction is performed, any one of an intra-screen prediction, an inter-screen prediction, and an inter-layer prediction can be selected and used. In the inter-layer prediction, an encoded image of a base layer is magnified and used for the enhancement layer prediction.

### CITATION LIST

### Non Patent Literature

Non Patent Literature 1: MPEG-4 AVC (ISO/IEC 14496-10)/ITU-T H.264 standard

### SUMMARY OF INVENTION

### Technical Problem

A conventional image encoding apparatus needs to encode all pixels of an enhancement layer using any one of an intra-screen prediction, an inter-screen prediction, and an inter-layer prediction to encode the enhancement layer. An image of an enhancement layer which is a predicted image needs to be encoded to encode the enhancement layer by the inter-screen prediction.

Furthermore, a conventional image decoding apparatus needs to decode all pixels of an enhancement layer to decode the enhancement layer. An image of an enhancement layer which is a predicted image needs to be decoded when the enhancement layer is encoded by the inter-screen prediction.

As described above, in order to encode image data of an enhancement layer and decode encoded data, a conventional image encoding apparatus and image decoding apparatus need to encode and decode all pixels of the enhancement layer, and to encode and decode an enhancement layer which is a predicted image. Thus, a conventional image encoding apparatus and image decoding apparatus have a problem that computational complexity is to be large.

The present invention is made to solve the above problems, and to reduce computational complexity related to encoding processing and decoding processing for image data in an image encoding apparatus and an image decoding apparatus.

### Solution to Problem

An image encoding apparatus according to the present invention includes:

an image transformation unit to receive a first image signal, which indicates an image, with a first resolution, transform the first image signal to a second image signal with a second resolution lower than the first resolution, and output the second image signal;

a region acquisition unit to acquire a part of a region of the image as a partial region;

a region information output unit to output first region information indicating the partial region;

a first encoding unit to receive the first image signal and the first region information output by the region information output unit, acquire a signal corresponding to the partial region indicated by the first region information from the first image signal as a partial region signal, encode the acquired partial region signal, and output the encoded partial region signal as a first encoded signal;

a second encoding unit to receive the second image signal output by the image transformation unit, encode the second image signal, and output the encoded second image signal as a second encoded signal; and

an output unit to output an encoded signal including the second encoded signal output by the second encoding unit and the first encoded signal output by the first encoding unit.

### Advantageous Effects of Invention

With an image encoding apparatus according to the present invention, an image transformation unit transforms a first image signal, which indicates an image, with a first resolution to a second image signal with a second resolution lower than the first resolution, a region acquisition unit acquires a partial region, a region information output unit outputs first region information indicating the partial region, a first encoding unit acquires a signal corresponding to the partial region from the first image signal as a partial region signal and encodes the partial region signal, a second encoding unit encodes the second image signal and outputs the second image signal as a second encoded signal, and an output unit outputs the second encoded signal and the first encoded signal, and thus it is possible to reduce computational complexity for encoding since an image is encoded with the second resolution lower than first resolution and only the partial region is encoded with the first resolution.

### BRIEF DESCRIPTION OF DRAWINGS

FIG. 1 is a block diagram illustrating an example of an image encoding apparatus 100 according to a first embodiment.

FIG. 2 is a diagram illustrating an example of a hardware configuration of the image encoding apparatus 100 and an image decoding apparatus 600 (see FIG. 7) according to the first embodiment.

FIG. 3 is a flowchart illustrating an example of low-resolution image encoding processing (process) in an image encoding method of the image encoding apparatus 100 according to the first embodiment.

FIG. 4 is a diagram for explaining attention region extraction processing (process) according to the first embodiment.

FIG. 5 is a flowchart illustrating an example of high-resolution image encoding processing (process) in the image encoding method of the image encoding apparatus 100 according to the first embodiment.

FIG. 6 is a diagram for explaining high-resolution image encoding processing (process) according to the first embodiment.

FIG. 7 is a block diagram illustrating an example of an image decoding apparatus 600 according to a second embodiment.

FIG. 8 is a flowchart illustrating an example of low-resolution image decoding processing (process) in an image decoding method of the image decoding apparatus 600 according to the second embodiment.

FIG. 9 is a flowchart illustrating an example of high-resolution image decoding processing (process) in the image decoding method of the image decoding apparatus 600 according to the second embodiment.

FIG. 10 is a diagram for explaining the high-resolution image decoding processing (process) according to the second embodiment.

FIG. 11 is a diagram for explaining the high-resolution image decoding processing (process) according to the second embodiment.

### DESCRIPTION OF EMBODIMENTS

### First Embodiment

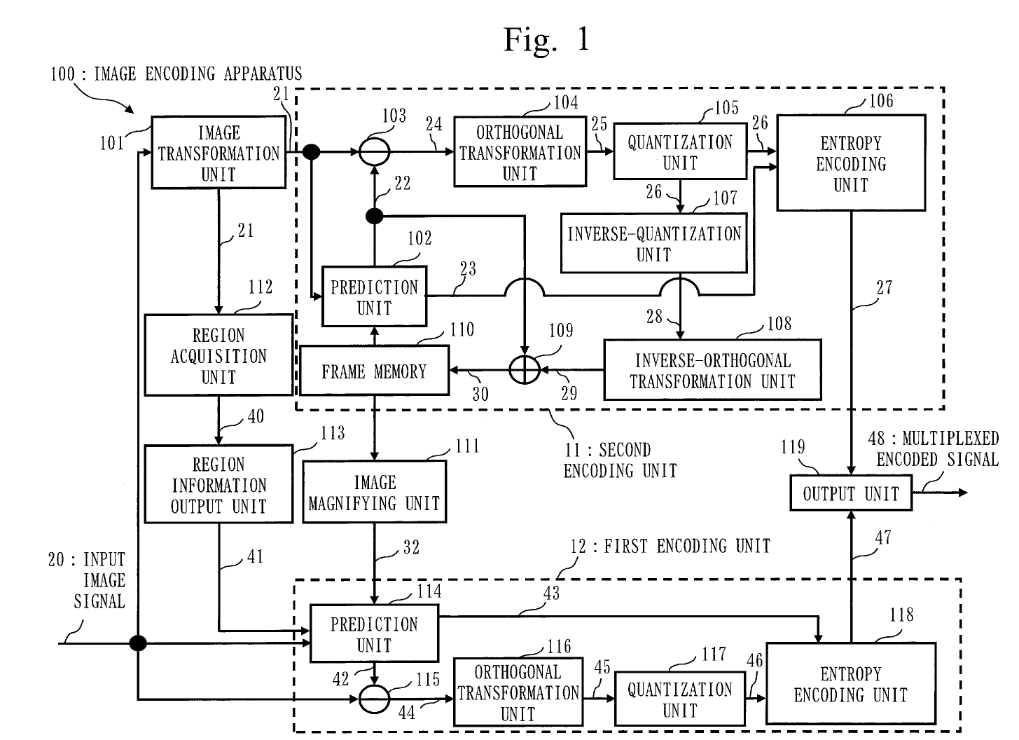

FIG. 1 is a block diagram illustrating an example of an image encoding apparatus 100 according to the present embodiment.

In FIG. 1, the image encoding apparatus 100 includes an image transformation unit 101, a region acquisition unit 112, a region information output unit 113, a second encoding unit 11, an image magnifying unit 111, an output unit 119, and a first encoding unit 12.

The second encoding unit 11 (a low-resolution image encoding unit) includes a prediction unit 102, a subtraction unit 103, an orthogonal transformation unit 104, a quantization unit 105, an entropy encoding unit 106, an inverse-quantization unit 107, an inverse-orthogonal transformation unit 108, an addition unit 109, and a frame memory 110.

The first encoding unit 12 (a high-resolution image encoding unit) includes a prediction unit 114, a subtraction unit 115, an orthogonal transformation unit 116, a quantization unit 117, and an entropy encoding unit 118.

The image transformation unit 101 reduces an input image signal 20 by n/m times, and outputs the reduced input image signal 20 as a low-resolution image signal 21. Here, n and m are integers, and n<m is established. The image transformation unit 101 transforms (reduces) the input image signal 20 (a first image signal), which indicates an image, with a first resolution (high resolution) to a second image signal with a second resolution (low resolution) lower than first resolution, and outputs the low-resolution image signal 21 (a second image signal). The image transformation unit 101 is also referred to as an image reduction unit.

The second encoding unit 11 encodes the low-resolution image signal 21 output by the image transformation unit 101, and outputs the encoded low-resolution image signal 21 as a low-resolution encoded signal 27 (a second encoded signal). The second encoding unit 11 is also referred to as a low-resolution image encoding unit.

The prediction unit 102 divides the low-resolution image signal 21 output by the image transformation unit 101 into block units, such as 16×16 pixel units. The prediction unit 102 performs an intra-screen prediction or an inter-screen prediction with each of the divided low-resolution image signals and a reference image signal 31 stored in the frame memory 110. Then, the prediction unit 102 outputs a low-resolution prediction image signal 22 and low-resolution prediction information 23.

The subtraction unit 103 subtracts the low-resolution prediction image signal 22 output by the prediction unit 102 from the low-resolution image signal 21 output by the image transformation unit 101, and outputs a low-resolution difference image signal 24.

The orthogonal transformation unit 104 orthogonally transforms the low-resolution difference image signal 24, and outputs a low-resolution orthogonal transformation coefficient 25.

The quantization unit 105 quantizes the low-resolution orthogonal transformation coefficient 25, and outputs a low-resolution difference quantization coefficient 26.

The entropy encoding unit 106 entropy-encodes the low-resolution difference quantization coefficient 26 and the low-resolution prediction information 23, and outputs the low-resolution encoded signal 27.

The inverse-quantization unit 107 inversely quantizes the low-resolution difference quantization coefficient 26, and outputs a decoded orthogonal transformation coefficient 28.

The inverse-orthogonal transformation unit 108 inversely orthogonally transforms the decoded orthogonal transformation coefficient 28, and outputs a decoded difference image signal 29.

The addition unit 109 adds the decoded difference image signal 29 to the low-resolution prediction image signal 22, and outputs a decoded image signal 30.

The frame memory 110 stores the decoded image signal 30 as the reference image signal 31.

The image magnifying unit 111 magnifies the reference image signal 31 stored in the frame memory 110 by m/n times, and outputs a magnified reference image signal 32. Here, m and n are the same values as those used in the image transformation unit 101. Furthermore, the image signal at the same time as the input image signal 20, that is, the decoded image signal 30 at the time when the same image is reduced and encoded is used as the reference image signal 31.

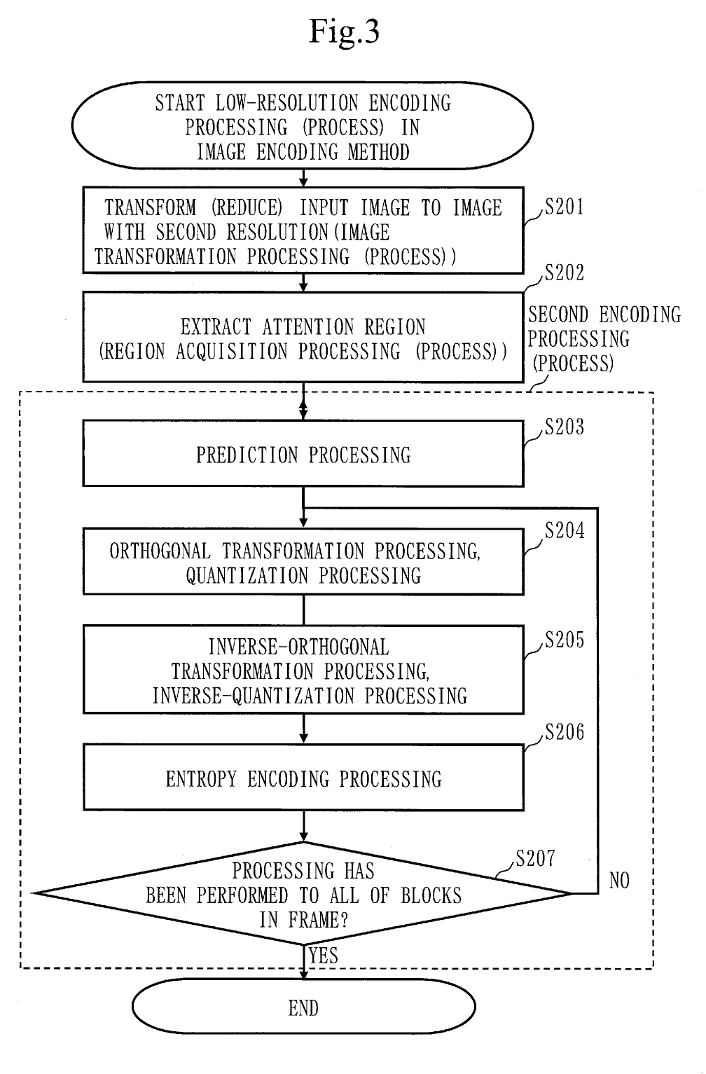

The region acquisition unit 112 (an attention region extraction unit) receives the low-resolution image signal 21 from the image transformation unit 101, and acquires, based on the low-resolution image signal 21, a partial region of the image as an attention region 40 (partial information). The region acquisition unit 112 extracts the attention region 40 from the low-resolution image signal 21. The attention region 40 is a region where a difference value between, for example, a background image signal 33 (see FIG. 3) and the low-resolution image signal 21 (the current image) is equal to or more than a first threshold. The region acquisition unit 112 is also referred to as an attention region extraction unit which extracts the attention region 40.

In other words, the region acquisition unit 112 acquires, from the low-resolution image signal 21, the background image signal 33 (a low resolution background image) indicating a background image set as a background of the image, and calculates a difference value between the background image signal 33 and the low-resolution image signal 21 for each pixel. The region acquisition unit 112 extracts a pixel in which the difference value is equal to or more than first threshold as a determination pixel, and acquires a region including the determination pixel as the attention region 40. Alternatively, the region acquisition unit 112 may acquire a region, where a ratio of the number of determination pixels to the number of pixels per unit area is equal to or more than a second threshold, as the attention region 40.

The region acquisition unit 112 extracts, for example, one or more rectangular regions as the attention region 40. Alternatively, the region acquisition unit 112 may extract one or more arbitrary shape regions as the attention region 40.

Furthermore, the region acquisition unit 112 extracts the attention region 40 based on an intra-screen prediction cost for each macroblock. Alternatively, the region acquisition unit 112 may extract the attention region 40 based on an inter-screen prediction cost for each macroblock. The region acquisition unit 112 is also referred to as an attention region extraction unit which extracts the attention region 40.

The region information output unit 113 (an attention region magnifying unit) outputs, as region information 41 (first region information), information indicating the region corresponding to the attention region 40 (partial region) when the image is displayed with the first resolution.

The region information output unit 113 outputs a magnified attention region obtained by magnifying the attention region 40 by m/n times as the region information 41. The region information 41 indicates the position of the attention region 40 of the image.

The prediction unit 114 divides, in the region information 41 output by the region information output unit 113, the input image signal 20 into block units, performs an inter-layer prediction of the magnified reference image signal 32 output by the image magnifying unit 111, and outputs a high-resolution prediction image signal 42 and high-resolution prediction information 43.

The subtraction unit 115 subtracts the high-resolution prediction image signal 42 from the input image signal 20 in the region information 41, and outputs a high-resolution difference image signal 44.

The orthogonal transformation unit 116 orthogonally transforms the high-resolution difference image signal 44, and outputs a high-resolution orthogonal transformation coefficient 45.

The quantization unit 117 quantizes the high-resolution orthogonal transformation coefficient 45, and outputs a high-resolution difference quantization coefficient 46.

The entropy encoding unit 118 entropy-encodes the high-resolution difference quantization coefficient 46 and the high-resolution prediction information 43, and outputs a high-resolution encoded signal 47.

The output unit 119 outputs a multiplexed encoded signal 48 (an example of an encoded signal) including the low-resolution encoded signal 27 and the high-resolution encoded signal 47. The output unit 119 is a multiplexing unit which multiplexes the low-resolution encoded signal 27 and the high-resolution encoded signal 47, and outputs the multiplexed signal as the multiplexed encoded signal 48.

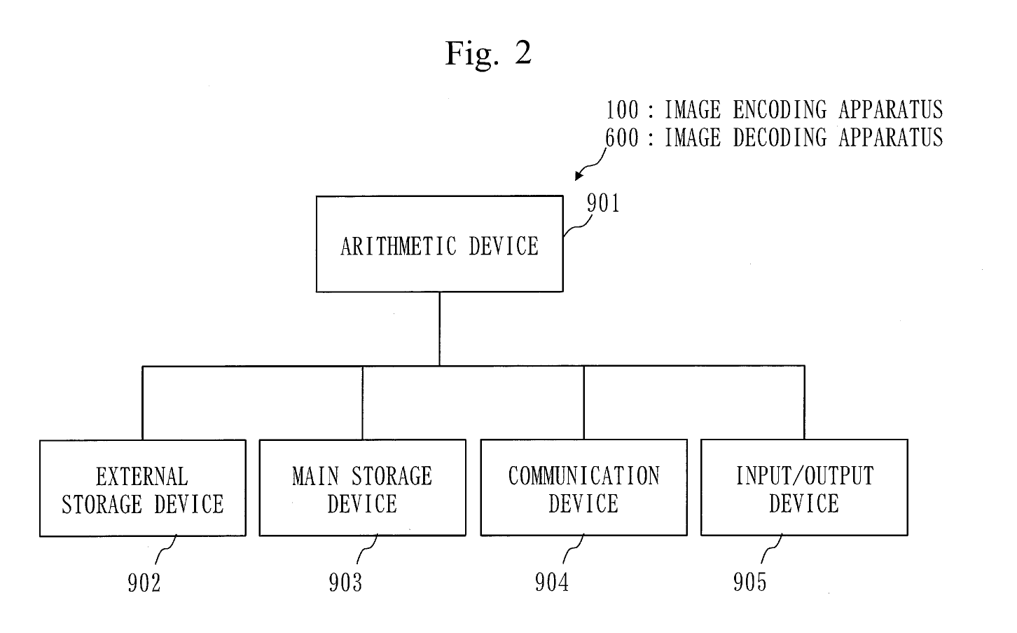

FIG. 2 is a diagram illustrating an example of a hardware configuration of the image encoding apparatus 100 and an image decoding apparatus 600 according to the present embodiment.

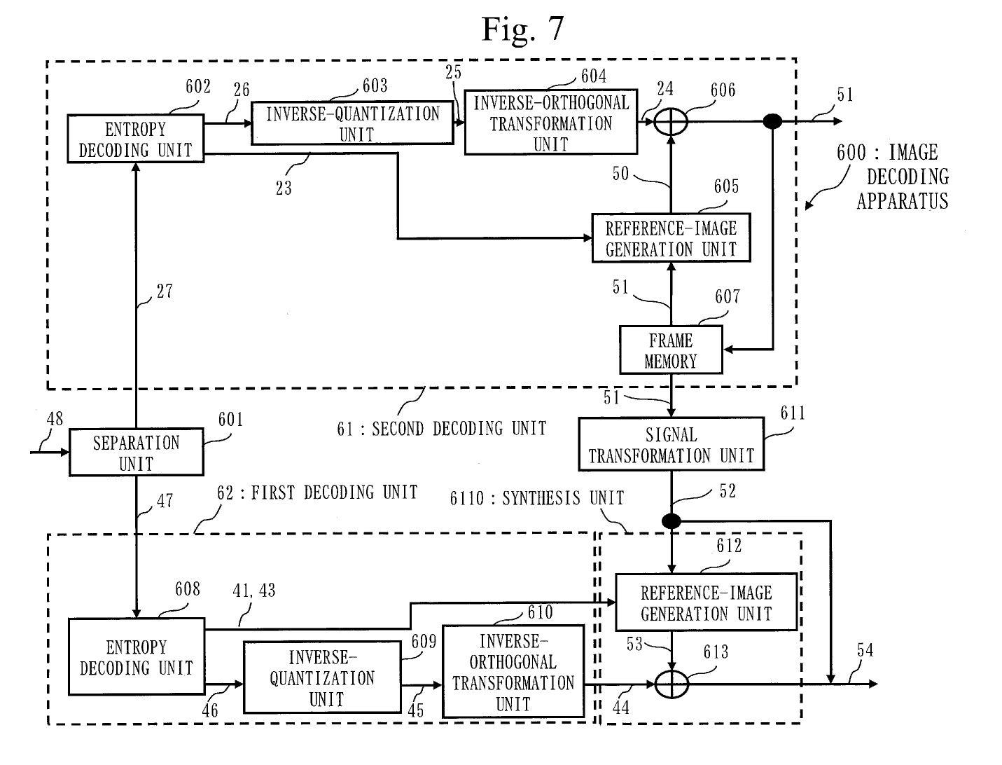

With reference to FIG. 2, the hardware configuration example of the image encoding apparatus 100 and the image decoding apparatus 600 (see FIG. 7) will be described.

The image encoding apparatus 100 and the image decoding apparatus 600 each are a computer, and the elements of the image encoding apparatus 100 and the image decoding apparatus 600 are implemented by programs.

In the hardware configuration of image encoding apparatus 100 and the image decoding apparatus 600, an arithmetic device 901, an external storage device 902, a main storage device 903, a communication device 904, and an input/output device 905 are connected with a bus.

The arithmetic device 901 is a central processing unit (CPU) which executes a program.

The external storage device 902 is, for example, a read only memory (ROM), a flash memory, or a hard disk device.

The main storage device 903 is a random access memory (RAM).

The communication device 904 is, for example, a communication board, and connected to a local area network (LAN) or the like. The communication device 904 may be connected to, in addition to the LAN, a wide area network (WAN), such as the internet protocol virtual private network (IP-VPN), the wide-area LAN, the asynchronous transfer mode (ATM) network, or the Internet. The LAN, the WAN, and the Internet are examples of a network.

The input/output device 905 is, for example, a mouse, a keyboard, a display device, and the like. A touch panel, a touch pad, a trackball, a pen tablet, or other pointing devices may be used instead of a mouse. The display device may be a liquid crystal display (LCD), a cathode ray tube (CRT), or other display devices.

The program is normally stored in the external storage device 902, sequentially read in the arithmetic device 901, and executed while being loaded in the main storage device 903.

The program implements a function explained as a “ . . . unit” illustrated in the block diagram.

A program product (a computer program product) is configured by a storage medium or a storage device which contains a program to implement a function of a “. . . unit” illustrated in FIG. 1 and the like. The program product has loaded a computer-readable program regardless of its appearance.

Furthermore, an operating system (OS) is also stored in the external storage device 902, at least a part of the OS is loaded in the main storage device 903, and the arithmetic device 901 executes the program which implements a “ . . . unit” illustrated in the block diagram while executing the OS.

An application program is stored in the external storage device 902, and is sequentially executed by the arithmetic device 901 while being loaded in the main storage device 903.

Information in a “ . . . table” is stored in the external storage device 902.

Furthermore, information, data, a signal value, or a variable value which indicate a result of processing, such as “judgement of . . . ”, “determination of . . . ”, “extraction of . . . ”, “detection of . . . ”, “setting of . . . ”, “registration of . . . ”, “selection of . . . ”, “generation of . . . ”, “input of . . . ”, “output of . . . ” and the like, are stored in the main storage device 903 as files.

Data received by the image encoding apparatus 100 and the image decoding apparatus 600 is stored in the main storage device 903.

An encryption key, a decryption key, a random number value, and a parameter may be stored in the main storage device 903 as files.

Note that, the configuration of FIG. 2 merely illustrates an example of the hardware configuration of the image encoding apparatus 100 and the image decoding apparatus 600. The hardware configuration of the image encoding apparatus 100 and the image decoding apparatus 600 is not limited to the configuration illustrated in FIG. 2, and may be other configurations.

FIG. 3 is a flowchart illustrating an example of first encoding processing (process) (low-resolution image encoding processing (process)) in an image encoding method of the image encoding apparatus 100 according to the present embodiment.

With reference to FIG. 3, the operations of the units in the image encoding processing (process) of the image encoding apparatus 100 will be described. In the image encoding processing (process) of the image encoding apparatus 100, the units of the image encoding apparatus 100 perform the first encoding processing (process) in cooperation with hardware resources of a processing device, a storage device, an input/output device, and the like which are included in the image encoding apparatus 100. In FIG. 3, second encoding processing (process) (low-resolution encoding processing (process)) in the image encoding processing (process) of the image encoding apparatus 100 will be described.

<S201: Image Transformation Processing>

First, in step S201, the image transformation unit 101 reduces the input image signal 20 by n/m times, and outputs the low-resolution image signal 21.

<S202: Region Acquisition Processing>

In step S202, the region acquisition unit 112 extracts the attention region 40 from the low-resolution image signal 21.

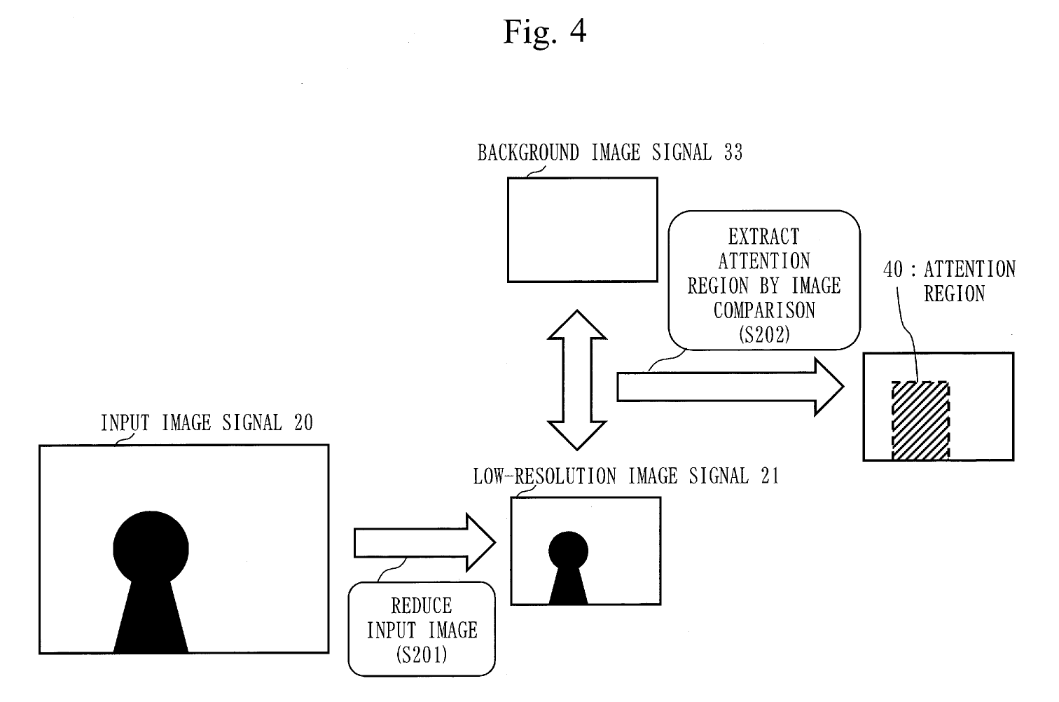

FIG. 4 is a diagram for explaining region acquisition processing (process) (attention region extraction processing (process)) according to the present embodiment.

The image encoding apparatus 100 acquires the background image signal 33 from the low-resolution image signal 21. The region acquisition unit 112 calculates a difference value between the acquired background image signal 33 and the low-resolution image signal 21 for each pixel with the processing device. The region acquisition unit 112 determines, as the attention region 40, a region including a pixel, in which the calculated difference value is equal to or more than the predetermined first threshold, as the determination pixel. The image encoding apparatus 100 may store the background image signal 33 in the storage device in advance. Alternatively, the image encoding apparatus 100 may calculate the background image signal 33 from the input image signal 20.

Alternatively, the region acquisition unit 112 may calculate, based on the input image signal 20, a region where there is movement, and determine the calculated region where there is movement, as the attention region 40.

As described above, the attention region 40 may be a rectangular region, or may be other shape regions.

<S203 to S207: Second Encoding Processing>

In step S203, the prediction unit 102 divides the low-resolution image signal 21 which is a frame, into block units. The prediction unit 102 performs an intra-screen prediction, an inter-screen prediction, or an inter-frame prediction based on the low-resolution image signal 21 divided into block units and the reference image signal 31 stored in the frame memory 110, and outputs the low-resolution prediction image signal 22 and the low-resolution prediction information 23. At this time, the prediction unit 102 performs the prediction using the low-resolution image signal 21 and a past reference image signal 31 stored in the frame memory 110. The subtraction unit 103 subtracts the low-resolution prediction image signal 22 output by the prediction unit 102 from the low-resolution image signal 21 output by the image transformation unit 101, and outputs the low-resolution difference image signal 24.

In step S204, the orthogonal transformation unit 104 orthogonally transforms the low-resolution difference image signal 24, and outputs the low-resolution orthogonal transformation coefficient 25. The quantization unit 105 quantizes the low-resolution orthogonal transformation coefficient 25, and outputs a low-resolution difference quantization coefficient 26.

In step S205, the inverse-quantization unit 107 inversely quantizes the low-resolution difference quantization coefficient 26, and outputs the decoded orthogonal transformation coefficient 28. The inverse-orthogonal transformation unit 108 inversely orthogonally transforms the decoded orthogonal transformation coefficient 28, and outputs a decoded difference image signal 29.

In step S206, the entropy encoding unit 106 entropy-encodes the low-resolution difference quantization coefficient 26 and the low-resolution prediction information 23, and outputs the low-resolution encoded signal 27.

In step S207, the prediction unit 102 determines whether the encoding processing has been performed to all of the blocks in the frame. When the encoding processing has been performed to all of the blocks in the frame (YES in S207), the low-resolution encoding processing is terminated. When there is a block, to which the encoding processing has not been performed, in the frame (NO in S207), the processing returns back to S203, and the encoding processing is performed to the next block.

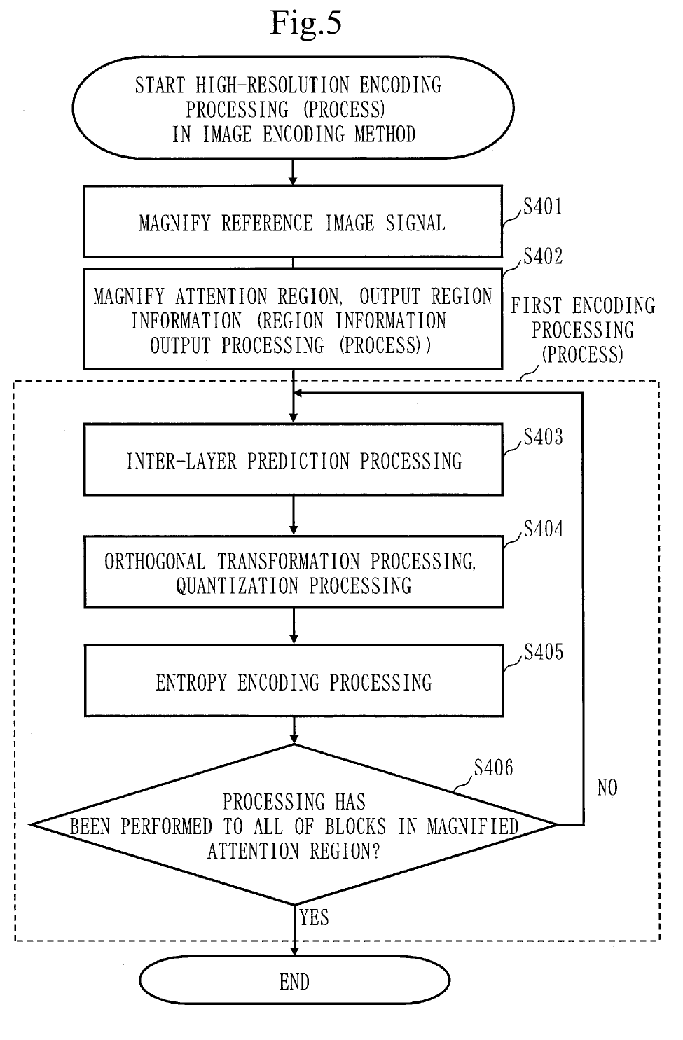

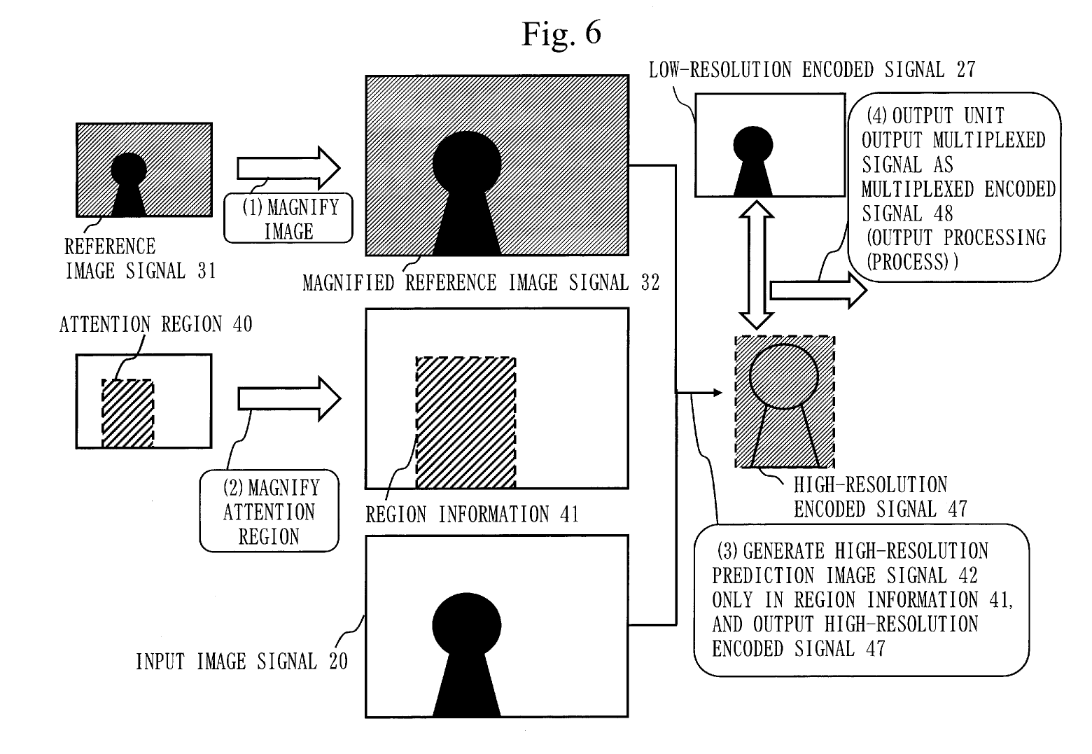

FIG. 5 is a flowchart illustrating an example of high-resolution image encoding processing (process) in an image encoding method of an image encoding apparatus 100 according to the present embodiment. FIG. 6 is a diagram for explaining the first encoding processing (process) (high-resolution image encoding processing (process)) according to the present embodiment.

With reference to FIGS. 5 and 6, the operations of the units in the high-resolution image encoding processing (process) of the image encoding apparatus 100 will be described. In the high-resolution image encoding processing (process) of the image encoding apparatus 100, the units of the image encoding apparatus 100 perform the image encoding processing (process) in cooperation with hardware resources of a processing device, a storage device, an input/output device, and the like which are included in the image encoding apparatus 100.

In step S401, the image magnifying unit 111 magnifies the reference image signal 31 stored in the frame memory 110 by m/n times, and outputs the magnified reference image signal 32 (see FIG. 6 (1)). At this time, the image magnifying unit 111 uses, as the reference image signal 31, the decoded image signal 30 which is the image signal at the same time as the input image signal 20, that is, the image signal when the same image is reduced and encoded.

<S402: Region Information Output Processing (Process)>

In step S402, the region information output unit 113 magnifies the attention region 40 by m/n times, and outputs the region information 41 (see FIG. 6 (2)).

When the image is displayed with the first resolution (high resolution), the region information output unit 113 outputs, as the region information 41, the information indicating the region corresponding to the attention region 40. The attention region 40 acquired based on the low-resolution image signal 21 is the information indicating the position of the attention region 40 when the image is displayed with the second resolution (low resolution). Thus, the region information output unit 113 magnifies the attention region 40, and outputs the magnified attention region 40 as the region information 41.

<S403 to S406: First Encoding Processing>

In step S403, the prediction unit 114 divides, in the region information 41 output by the region information output unit 113, the input image signal 20 into block units, performs the inter-layer prediction of the magnified reference image signal 32 output by the image magnifying unit 111, and outputs the high-resolution prediction image signal 42 and the high-resolution prediction information 43 (see FIG. 6 (3)). Then, the subtraction unit 115 subtracts the high-resolution prediction image signal 42 output by the prediction unit 114 from the input image signal 20, and outputs the high-resolution difference image signal 44.

In step S404, the orthogonal transformation unit 116 orthogonally transforms the high-resolution difference image signal 44, and outputs the high-resolution orthogonal transformation coefficient 45. The quantization unit 117 quantizes the high-resolution orthogonal transformation coefficient 45, and outputs a high-resolution difference quantization coefficient 46.

In step S405, the entropy encoding unit 118 entropy-encodes the high-resolution difference quantization coefficient 46 and the high-resolution prediction information 43, and outputs the high-resolution encoded signal 47 (see FIG. 6 (3)).

In step S406, the prediction unit 114 determines whether the encoding processing has been performed to all of the blocks in the frame. When the encoding processing has been performed to all of the blocks in the frame (YES in S406), the high-resolution encoding processing is terminated. When there is a block, to which the encoding processing has not been performed, in the frame (NO in S406), the processing returns back to S403, and the encoding processing is performed to the next block.

<Output Processing>

As illustrated in FIG. 6 (4), the output unit 119 multiplexes the low-resolution encoded signal 27 output by the second encoding unit 11 and the high-resolution encoded signal 47 output by the first encoding unit 12, and outputs the multiplexed signal as the multiplexed encoded signal 48 (output processing (process)).

Note that, in the present embodiment, the background image signal 33 has been prepared, and a rectangular region including a pixel, in which the pixel difference value is equal to or more than a predetermined threshold, is determined as the attention region 40. However, the attention region 40 may be calculated based on a prediction cost calculated during the low-resolution encoding.

Furthermore, although a rectangular region is calculated as the attention region in the above description, multiple arbitrary regions may be extracted as the attention region.

Moreover, in the present embodiment, the attention region 40 is extracted from the low-resolution image signal 21 which is the image expressed with a low resolution. However, the attention region 40 may be extracted from, for example, the input image signal 20 which is the image expressed with a high resolution. In this case, the region information output unit 113 does not need to magnify the attention region 40.

Note that, by extracting the attention region 40 from the low-resolution image signal 21, it is possible to reduce the computational complexity related to the extraction of the attention region 40.

As described above, the image encoding apparatus according to the present embodiment determines an attention region in an image, and performs inter-layer encoding only to the attention region to encode image data of an enhancement layer (high-resolution image). The encoding is not performed to other region except for the attention region. By this processing, it is possible to reduce the computational complexity related to the encoding processing for image data.

According to the invention, when encoding an image with a first resolution, the image encoding apparatus performs inter-layer prediction processing only to an attention region using an image obtained by magnifying a local decoded image of a second encoded signal as a reference image, and uses the image obtained by magnifying the local decoded image of the second encoded signal as the region other than the attention region, and thus it is possible to reduce the processing amount for encoding an image signal with the first resolution.

As described above, the image encoding apparatus according to the present embodiment includes an image transformation unit which reduces an input image signal and outputs a low-resolution image signal, a region acquisition unit which extracts an attention region from the low-resolution image signal, an image magnifying unit which magnifies a low-resolution reference image signal and outputs a magnified reference image signal, a region information output unit which magnifies the attention region and outputs a magnified attention region (region information), and a high-resolution encoding unit which performs an inter-layer prediction of the input image signal and the magnified reference image signal only to the magnified attention region and performs encoding, and thus it is possible to reduce the computational complexity for encoding a high resolution image. Furthermore, the encoding is performed only to the magnified attention region, and it is possible to reduce the data amount of the high-resolution encoded signal.

### Second Embodiment

In the present embodiment, the different points from the first embodiment will be mainly described.

The component units having the same functions as those described in the first embodiment have the same reference signs, and the description of them may be omitted.

FIG. 7 is a block diagram illustrating an example of an image decoding apparatus 600 according to the present embodiment.

As illustrated in FIG. 7, the image decoding apparatus 600 includes a separation unit 601, a second decoding unit 61 (a low-resolution image decoding unit), a first decoding unit 62 (a high-resolution image decoding unit), a signal transformation unit 611 (an image magnifying unit), and a synthesis unit 6110.

The second decoding unit 61 includes an entropy decoding unit 602, an inverse-quantization unit 603, an inverse-orthogonal transformation unit 604, a reference-image generation unit 605, an addition unit 606, and a frame memory 607.

The first decoding unit 62 includes an entropy decoding unit 608, an inverse-quantization unit 609, and an inverse-orthogonal transformation unit 610.

The synthesis unit 6110 includes a reference-image generation unit 612, and an addition unit 613. The first decoding unit 62 may include the synthesis unit 6110.

The separation unit 601 acquires a multiplexed encoded signal 48. The separation unit 601 separates the acquired multiplexed encoded signal 48 into a low-resolution encoded signal 27 and a high-resolution encoded signal 47.

The entropy decoding unit 602 entropy-decodes the low-resolution encoded signal 27 output by the separation unit 601, and outputs a low-resolution difference quantization coefficient 26 and low-resolution prediction information 23.

The inverse-quantization unit 603 inversely quantizes the low-resolution difference quantization coefficient 26, and outputs a low-resolution orthogonal transformation coefficient 25.

The inverse-orthogonal transformation unit 604 inversely orthogonally transforms the low-resolution orthogonal transformation coefficient 25, and outputs a low-resolution difference image signal 24.

The reference-image generation unit 605 generates a low-resolution reference image signal 50 from the low-resolution prediction information 23 and a low-resolution decoded image signal 51 stored in the frame memory 607.

The addition unit 606 adds the low-resolution difference image signal 24 to the low-resolution reference image signal 50, and outputs the low-resolution decoded image signal 51.

The frame memory 607 stores the low-resolution decoded image signal 51.

The second decoding unit 61 decodes the low-resolution encoded signal 27 separated by the separation unit 601 to the low-resolution decoded image signal 51 (a second decoded signal).

The entropy decoding unit 608 entropy-decodes the high-resolution encoded signal 47 output by the separation unit 601, and outputs a high-resolution difference quantization coefficient 46, high-resolution prediction information 43, and region information 41.

The inverse-quantization unit 609 inversely quantizes the high-resolution difference quantization coefficient 46, and outputs a high-resolution orthogonal transformation coefficient 45.

The inverse-orthogonal transformation unit 610 inversely orthogonally transforms the high-resolution orthogonal transformation coefficient 45, and outputs a high-resolution difference image signal 44.

The first decoding unit 62 decodes the high-resolution encoded signal 47 separated by the separation unit 601 to the high-resolution difference image signal 44 (a first decoded signal).

The signal transformation unit 611 transforms the low-resolution decoded image signal 51 output by the second decoding unit 61 to a magnified decoded image signal 52 (a transformed signal) with a first resolution. Specifically, the signal transformation unit 611 magnifies the low-resolution decoded image signal 51 stored in the frame memory 607 by m/n times, and outputs the magnified decoded image signal 52. Here, n and m are integers, and n<m is established.

The synthesis unit 6110 generates, based on the high-resolution difference image signal 44 output by the first decoding unit 62 and the magnified decoded image signal 52 output by the signal transformation unit 611, a high-resolution decoded image signal (a synthesized signal) with the first resolution.

The reference-image generation unit 612 generates a high resolution reference image signal 53 from the high-resolution prediction information 43 and the magnified decoded image signal 52.

The addition unit 613 adds the high resolution reference image signal 53 to the high-resolution difference image signal 44, and outputs a high-resolution decoded image signal 54 (a synthesized signal).

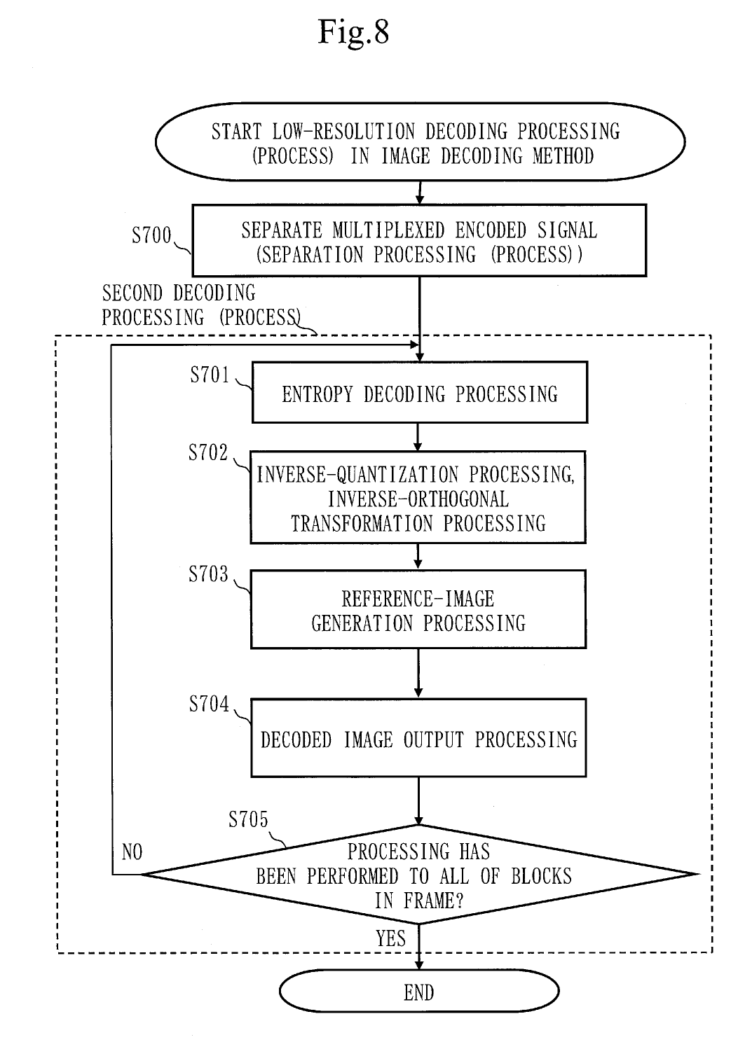

FIG. 8 is a flowchart illustrating an example of image decoding processing (process) in an image decoding method of the image decoding apparatus 600 according to the present embodiment.

With reference to FIG. 8, the operations of the units in low-resolution image decoding processing (process) in the image decoding processing (process) of the image decoding apparatus 600 will be described. The units of the image decoding apparatus 600 perform the low-resolution image decoding processing (process) in cooperation with hardware resources, such as a processing device, a storage device, and an input/output device, which are included in the image decoding apparatus 600.

<S700: Multiplex and Separation Processing (Process)>

In step S700, the separation unit 601 acquires the multiplexed encoded signal 48 obtained by multiplexing the high-resolution encoded signal 47 and the low-resolution encoded signal 27. The high-resolution encoded signal 47 is obtained by encoding a region corresponding to an attention region 40 with a high resolution. The low-resolution encoded signal 27 is obtained by encoding the whole region of the image with a low resolution. The separation unit 601 separates the acquired multiplexed encoded signal 48, and acquires the high-resolution encoded signal 47 and the low-resolution encoded signal 27.

<S701 to S705: Second Decoding Processing (Process)>

In step S701, the entropy decoding unit 602 entropy-decodes the low-resolution encoded signal 27 output by the separation unit 601, and outputs the low-resolution difference quantization coefficient 26 and the low-resolution prediction information 23.

In step S702, the inverse-quantization unit 603 inversely quantizes the low-resolution difference quantization coefficient 26, and outputs the low-resolution orthogonal transformation coefficient 25. The inverse-orthogonal transformation unit 604 inversely orthogonally transforms the low-resolution orthogonal transformation coefficient 25, and outputs a low-resolution difference image signal 24.

In step S703, the reference-image generation unit 605 generates the low-resolution reference image signal 50 from the low-resolution prediction information 23 output by the entropy decoding unit 602 and the low-resolution decoded image signal 51 stored in the frame memory 607.

In step S704, the addition unit 606 adds the low-resolution reference image signal 50 to the low-resolution difference image signal 24, and outputs the low-resolution decoded image signal 51. The frame memory 607 stores the low-resolution decoded image signal 51.

In step S705, the entropy decoding unit 602 determines whether the decoding processing has been performed to all of the blocks in the frame. When the decoding processing has been performed to all of the blocks in the frame (YES in S705), the low-resolution decoding processing is terminated. When there is a block, to which the decoding processing has not been performed, in the frame (NO in S705), the processing returns back to S701, and the decoding processing is performed to the next block.

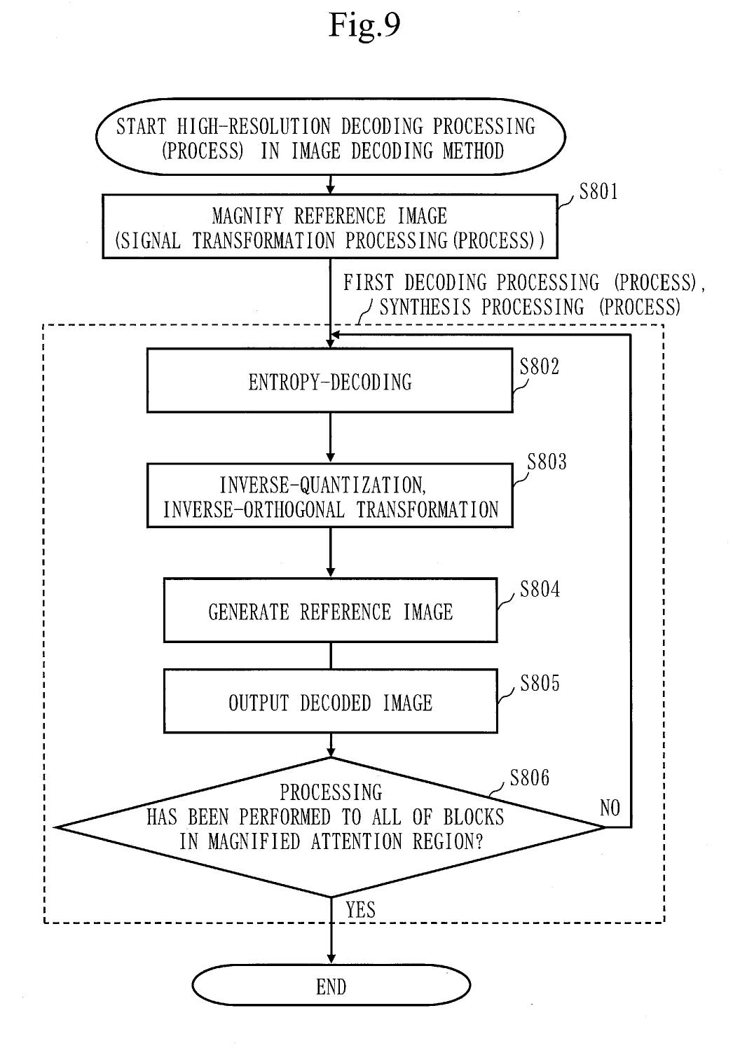

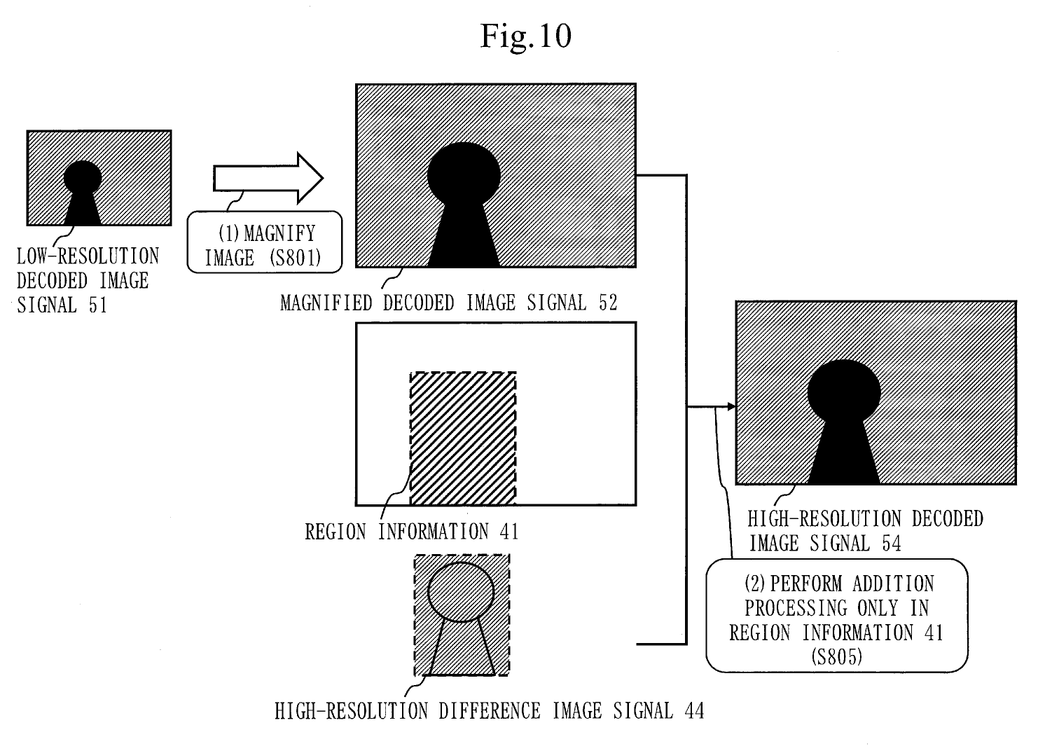

FIG. 9 is a flowchart illustrating an example of image decoding processing (process) in an image decoding method of the image decoding apparatus 600 according to the present embodiment. FIG. 10 is a diagram for explaining an example of the image decoding processing (process) according to the present embodiment.

With reference to FIGS. 9 and 10, the operations of the units in high-resolution image decoding processing (process) and synthesis processing (process) in the image decoding processing (process) of the image decoding apparatus 600 will be described. The units of the image decoding apparatus 600 perform the image decoding processing (process) in cooperation with hardware resources, such as a processing device, a storage device, and an input/output device, which are included in the image decoding apparatus 600.

<S801: Signal Transformation Processing>

First, in step S801, the signal transformation unit 611 magnifies the low-resolution decoded image signal 51 stored in the frame memory 607 by m/n times, and outputs the magnified decoded image signal 52 (see FIG. 10 (1)).

In step S802, the entropy decoding unit 608 entropy-decodes the high-resolution encoded signal 47 output by the separation unit 601, and outputs the high-resolution difference quantization coefficient 46, the high-resolution prediction information 43, and the attention region 40.

In step S803, the inverse-quantization unit 609 inversely quantizes the high-resolution difference quantization coefficient 46, and outputs the high-resolution orthogonal transformation coefficient 45. Furthermore, the inverse-orthogonal transformation unit 610 inversely orthogonally transforms the high-resolution orthogonal transformation coefficient 45, and outputs the high-resolution difference image signal 44.

In step S804, the reference-image generation unit 612 generates the high resolution reference image signal 53 from the high-resolution prediction information 43 and the magnified decoded image signal 52.

In step S805, the addition unit 613 adds the high-resolution difference image signal 44 to the attention region 40 of the high resolution reference image signal 53, and outputs the high-resolution decoded image signal 54 (see FIG. 10 (2)).

In step S806, the entropy decoding unit 608 determines whether the decoding processing has been performed to all of the blocks in the attention region output by the entropy decoding unit 608. When the decoding processing has been performed to all of the blocks (YES in S806), the high-resolution decoding processing is terminated.

When there is a block to which the decoding processing has not been performed (NO in S806), the processing returns back to S802, and the decoding processing is performed to the next block.

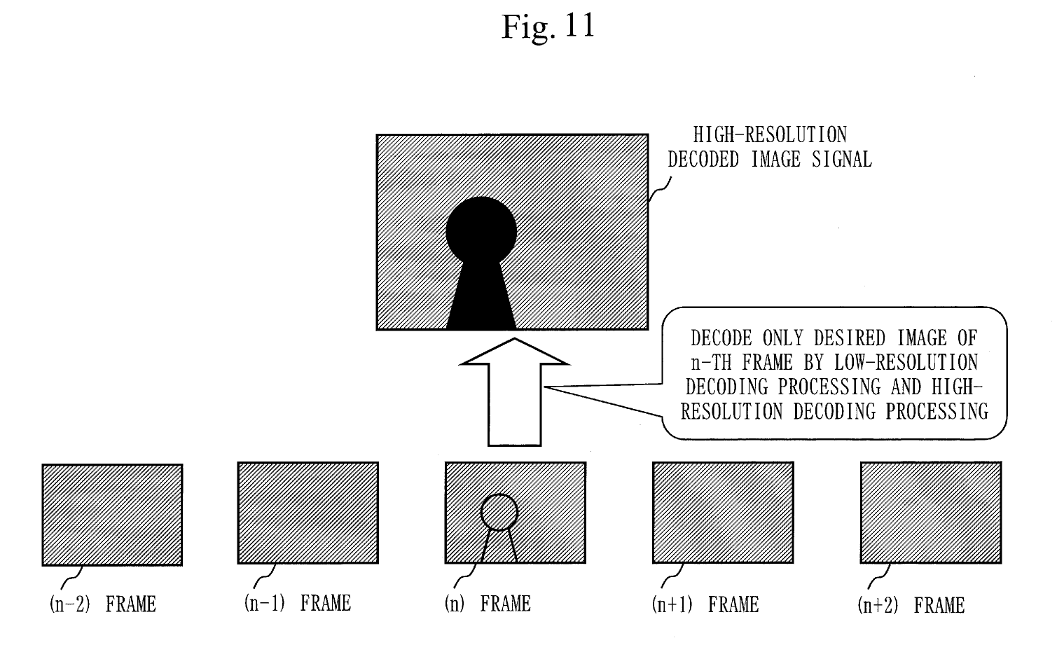

FIG. 11 is a diagram for explaining another example of image decoding processing (process) according to the present embodiment.

FIG. 11 illustrates that a multiplexed encoded signal 54 (encoded data) of a (n+2) frame to a (n−2) is to be decoded. Here, the first decoding processing (high-resolution decoding processing) is performed only to the n frame, and the second decoding processing (low-resolution decoding processing) is performed to other frames. As described above, with the image decoding apparatus 600 according to the present embodiment, the high-resolution decoding processing can be performed only to a desired frame. Thus, it is possible to reduce the computational complexity of the acquisition processing for the high-resolution decoded image signal of the frame.

As described above, the image decoding apparatus according to the present embodiment includes a low-resolution decoding unit which inputs a multiplexed encoded signal obtained by multiplexing a low-resolution encoded signal and a high-resolution encoded signal and decodes the low-resolution encoded signal, an image magnifying unit which magnifies a low-resolution reference image signal and outputs a magnified reference image signal, and a high-resolution decoding unit which adds a high-resolution difference image signal to the magnified reference image signal only in an attention region and outputs a high-resolution decoded image signal, and it is possible to reduce the computational complexity for decoding a high-resolution image.

Furthermore, with the image decoding apparatus according to the present embodiment, when the image decoding apparatus decodes a first encoded signal, an inter-layer prediction processing has been performed only to an attention region using an image obtained by magnifying a local decoded image of a second encoded signal as a reference image, and the image obtained by magnifying the local decoded image of the second encoded signal is used as the region other than the attention region, and it is possible to reduce processing amount for decoding a decoded image signal with a desired first resolution.

Moreover, the image encoding apparatus 100 according to the present embodiment is to reduce processing amount for decoding an image of a desired enhancement layer, by having encoded an attention region of encoded data using an inter-layer prediction, and by using an image obtained by magnifying an encoded image of a base layer as the image other than the attention region when the image decoding apparatus decodes the encoded data of the enhancement layer.

The configurations of an “image transformation unit”, a “region acquisition unit”, a “region information output unit”, an “image magnifying unit”, an “output unit”, a “first encoding unit”, and a “second encoding unit” of the image encoding apparatus 100 described in the above first embodiment are not limited to the first embodiment. These components are optional. For example, a “region acquisition unit” and a “region information output unit” may be implemented by a functional block, or an “image magnifying unit” and an “output unit” may be implemented by a functional block. Alternatively, the image encoding apparatus 100 may be configured in any combination of these functional blocks.

Similarly, the configurations of a “signal transformation unit”, a “separation unit”, a “first decoding unit”, and a “second decoding unit” of the image decoding apparatus 600 described in the above second embodiment are not limited to the second embodiment. These components are optional. The image decoding apparatus 600 may be configured in any combination of these functional blocks.

The first and second embodiments of the present invention have been described, and the two embodiments may be combined and performed. Alternatively, either of these embodiments may be partially performed. Alternatively, both of these embodiments may be partially performed. Note that, the present invention is not limited to these embodiments, and can be variously changed as needed.

### REFERENCE SIGNS LIST

11: second encoding unit, 12: first encoding unit, 20: input image signal, 21: low-resolution image signal, 22: low-resolution prediction image signal, 23: low-resolution prediction information, 24: low-resolution difference image signal, 25: low-resolution orthogonal transformation coefficient, 26: low-resolution difference quantization coefficient, 27: low-resolution encoded signal, 28: decoded orthogonal transformation coefficient, 29: decoded difference image signal, 30: decoded image signal, 31: reference image signal, 32: magnified reference image signal, 33: background image signal, 40: attention region, 41: region information, 42: high-resolution prediction image signal, 43: high-resolution prediction information, 44: high-resolution difference image signal, 45: high-resolution orthogonal transformation coefficient, 46: high-resolution difference quantization coefficient, 47: high-resolution encoded signal, 48: multiplexed encoded signal, 50: low-resolution reference image signal, 51: low-resolution decoded image signal, 52: magnified decoded image signal, 101: image transformation unit, 102: prediction unit, 103: subtraction unit, 104: orthogonal transformation unit, 105: quantization unit, 106: entropy encoding unit, 107: inverse-quantization unit, 108: inverse-orthogonal transformation unit, 109: addition unit, 110: frame memory, 111: image magnifying unit, 112: region acquisition unit, 113: region information output unit, 114: prediction unit, 115: subtraction unit, 116: orthogonal transformation unit, 117: quantization unit, 118: entropy encoding unit, 119: output unit, 61: second decoding unit, 62: first decoding unit, 600: image decoding apparatus, 601: separation unit, 602: entropy decoding unit, 603: inverse-quantization unit, 604: inverse-orthogonal transformation unit, 605: reference-image generation unit, 606: addition unit, 607: frame memory, 608: entropy decoding unit, 609: inverse-quantization unit, 610: inverse-orthogonal transformation unit, 611: signal transformation unit, 612: reference-image generation unit, 613: addition unit, 901: arithmetic device, 902: external storage device, 903: main storage device, 904: communication device, 905: input/output device, and 6110: synthesis unit

1. An image encoding apparatus comprising:
an image transformation unit to receive a first image signal, which indicates an image, with a first resolution, transform the first image signal to a second image signal with a second resolution lower than the first resolution, and output the second image signal;
a region acquisition unit to acquire a part of a region of the image as a partial region;
a region information output unit to output first region information indicating the partial region;
a first encoding unit to receive the first image signal and the first region information output by the region information output unit, acquire a signal corresponding to the partial region indicated by the first region information from the first image signal as a partial region signal, encode a partial region difference signal which is a difference between the acquired partial region signal and a signal of a region corresponding to the partial region of the second image signal, and output the encoded partial region difference signal as a first encoded signal;
a second encoding unit to receive the second image signal output by the image transformation unit, encode the second image signal, and output the encoded second image signal as a second encoded signal; and
an output unit to output an encoded signal including the second encoded signal output by the second encoding unit and the first encoded signal output by the first encoding unit.

2. The image encoding apparatus according to claim 1, wherein
the region acquisition unit receives the second image signal from the image transformation unit, and acquires, based on the second image signal, the part of the region of the image as the partial region, and
the region information output unit outputs information indicating a region corresponding to the partial region when the image is displayed with the first resolution, as the first region information.

3. The image encoding apparatus according to claim 2, wherein the region acquisition unit acquires, from the second image signal, a background image signal indicating a background image set as a background of the image, calculates a difference value between the background image signal and the second image signal for each pixel, extracts a pixel in which the difference value is equal to or more than a first threshold as a determination pixel, and acquires a region including the determination pixel as the partial region.

4. The image encoding apparatus according to claim 3, wherein the region acquisition unit acquires, as the partial region, a region where a ratio of the number of the determination pixels to the number of pixels per unit area is equal to or more than a second threshold.

5. The image encoding apparatus according to claim 1, wherein the region acquisition unit acquires at least one rectangular region as the partial region.

6. The image encoding apparatus according to claim 1, wherein the output unit multiplexes the first encoded signal and the second encoded signal, and outputs the multiplexed first encoded signal and second encoded signal as a multiplexed encoded signal.

7. An image decoding apparatus comprising:
a separation unit to acquire, from a first image signal with a first resolution, which is a partial image difference signal with the first resolution and indicates an image, a signal corresponding to a partial region, which is a part of a region of the image, as a partial region signal, receive an encoded signal including a first encoded signal obtained by encoding a partial image difference signal, which is a difference between the acquired partial region signal and a signal of a region corresponding to the partial region of a second image signal, which indicates the image, with a second resolution lower than the first resolution, and a second encoded signal obtained by encoding the second image signal, and separate the encoded signal into the first encoded signal and the second encoded signal;
a first decoding unit to receive the first encoded signal separated by the separation unit, decode the first encoded signal, and output the decoded first encoded signal as a first decoded signal;
a second decoding unit to receive the second encoded signal separated by the separation unit, decode the second encoded signal, and output the decoded second encoded signal as a second decoded signal;
a signal transformation unit to transform the second decoded signal output by the second decoding unit to a transformed signal with the first resolution, and output the transformed signal; and
a synthesis unit to generate a synthesized signal with the first resolution by adding the first decoded signal output by the first decoding unit to the region corresponding to the partial region of the transformed signal output by the signal transformation unit.

8. An image encoding method comprising:
receiving a first image signal, which indicates an image, with a first resolution, and transforming the first image signal to a second image signal with a second resolution lower than the first resolution by an image transformation unit;
acquiring a part of a region of the image as a partial region by a region acquisition unit;
outputting first region information indicating the partial region by a region information output unit;
receiving the first image signal and the first region information output by the region information output unit, acquiring a signal corresponding to the partial region indicated by the first region information from the first image signal as a partial region signal, encoding a partial region difference signal which is a difference between the acquired partial region signal and a signal of a region corresponding to the partial region of the second image signal, and outputting the encoded partial region difference signal as a first encoded signal by a first encoding unit;
receiving the second image signal output by the image transformation unit, encoding the second image signal, and outputting the encoded second image signal as a second encoded signal by a second encoding unit; and
outputting an encoded signal including the second encoded signal output by the second encoding unit and the first encoded signal output by the first encoding unit by an output unit.

9. An image decoding method comprising:
acquiring, from a first image signal with a first resolution, which is a partial image difference signal with the first resolution and indicates an image, a signal corresponding to a partial region, which is a part of a region of the image, as a partial region signal, receiving an encoded signal including a first encoded signal obtained by encoding a partial image difference signal, which is a difference between the acquired partial region signal and a signal of a region corresponding to the partial region of a second image signal, which indicates the image, with a second resolution lower than the first resolution, and a second encoded signal obtained by encoding the second image signal, and separating the encoded signal into the first encoded signal and the second encoded signal by a separation unit;
receiving the first encoded signal separated by the separation unit, decoding the first encoded signal, and outputting the decoded first encoded signal as a first decoded signal by a first decoding unit;
receiving the second encoded signal separated by the separation unit, decoding the second encoded signal, and outputting the decoded second encoded signal as a second decoded signal by a second decoding unit;
transforming the second decoded signal output by the second decoding unit to a transformed signal with the first resolution by a signal transformation unit; and
generating a synthesized signal with the first resolution by adding the first decoded signal output by the first decoding unit to the region corresponding to the partial region of the transformed signal output by the signal transformation unit by a synthesis unit.

10. A non-transitory computer readable medium storing a program causing a computer to execute:
image transformation processing to receive a first image signal, which indicates an image, with a first resolution, transform the first image signal to a second image signal with a second resolution lower than the first resolution, and output the second image signal;
region acquisition processing to acquire a part of a region of the image as a partial region;
region information output processing to output first region information indicating the partial region;
first encoding processing to receive the first image signal and the first region information output by the region information output processing, acquire a signal corresponding to the partial region indicated by the first region information from the first image signal as a partial region signal, encode a partial region difference signal which is a difference between the acquired partial region signal and a signal of a region corresponding to the partial region of the second image signal, and output the encoded partial region difference signal as a first encoded signal;
second encoding processing to receive the second image signal output by the image transformation processing, encode the second image signal, and output the encoded second image signal as a second encoded signal; and
output processing to output an encoded signal including the second encoded signal output by the second encoding processing and the first encoded signal output by the first encoding processing.

11. A non-transitory computer readable medium storing a program causing a computer to execute:
separation processing to acquire, from a first image signal with a first resolution, which is a partial image difference signal with the first resolution and indicates an image, a signal corresponding to a partial region which is a art of a region of the image, as a partial region signal, receive an encoded signal including a first encoded signal obtained by encoding a partial image difference signal, which is a difference between the acquired partial region signal and a signal of a region corresponding to the partial region of a second image signal which indicates the image, with a second resolution lower than the first resolution, and a second encoded signal obtained by encoding the second image signal, and separate the encoded signal into the first encoded signal and the second encoded signal;
first decoding processing to receive the first encoded signal separated by the separation processing, decode the first encoded signal, and output the decoded first encoded signal as a first decoded signal;
second decoding processing to receive the second encoded signal separated by the separation processing, decode the second encoded signal, and output the decoded second encoded signal as a second decoded signal;
signal transformation processing to transform the second decoded signal output by the second decoding processing to a transformed signal with the first resolution, and output the transformed signal; and
synthesis processing to generate a synthesized signal with the first resolution by adding the first decoded signal output by the first decoding processing to the region corresponding to the partial region of the transformed signal output by the signal transformation processing.
